(19) United States
(12) Patent Application Publication
(10) Pub. No.: US 2013/0045345 A1
(43) Pub. Date: Feb. 21, 2013

(54) Runner max towel

(71) Applicant: Mikal Sharrieff, Los Angeles, CA (US)

(72) Inventor: Mikal Sharrieff, Los Angeles, CA (US)

(21) Appl. No.: 13/385,725

(22) Filed: Aug. 16, 2011

(51) Int. Cl. B65D 33/00; B32B 1/02

(52) U.S. Cl. 428/35.2

(57) ABSTRACT

A method and apparatus for allowing the user the convenience of having a workout towel, communication devices, music devices, first aid items, cosmetic etc. while exercising.

The towel is designed for use without the weight of the accessory pouch.

The towel is not subject to being left on the workout bench, chair backs, locker or any place that may be inconvenient while exercising.

The accessory pouch is designed to contain money, first aid items, and music and communication devices.

The runner max towel is a towel and pouch combo made of terry cloth and has snap clips and Velcro for attachments to begin ware usage.

The runner max towel is designed to give the user maximum efficiency in addition to adhering to health risks.

(A) The apparatus is a terry pouch with plastic snap clips partially sown to be embedded between the terry thickness of the top portion of the back side of the pouch. The actual part of the snap clip that snaps to the trousers is not embedded. The snap clips are on the both ends of the top portion of the pouch and are visible on the back side of the pouch that attaches to the trousers, the top portion of the front side of the pouch is stitched with Velcro. (B) The terry towel that attaches to the terry pouch by way of Velcro is stitched with Velcro on the back side top of portion of the towel while the front side remains plane and has nothing added to it.

The pouch is for accessories, cell phone, first aid items, music device, etc.

(A) When the towel is used, the towel rips away from the Velcro portion of the pouch and is used to wipe perspiration and keep dry. (B) When the towel is in use it is free of the weight of the accessory pouch for maximum efficiency.

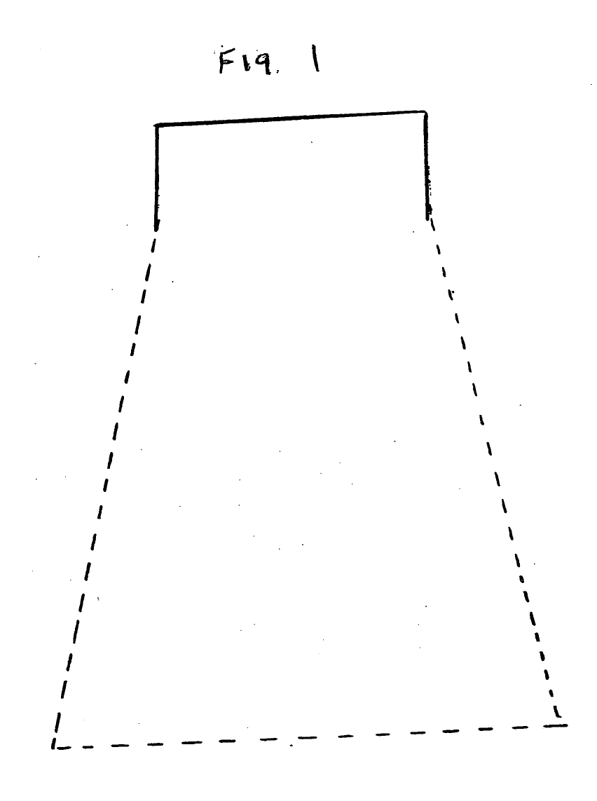

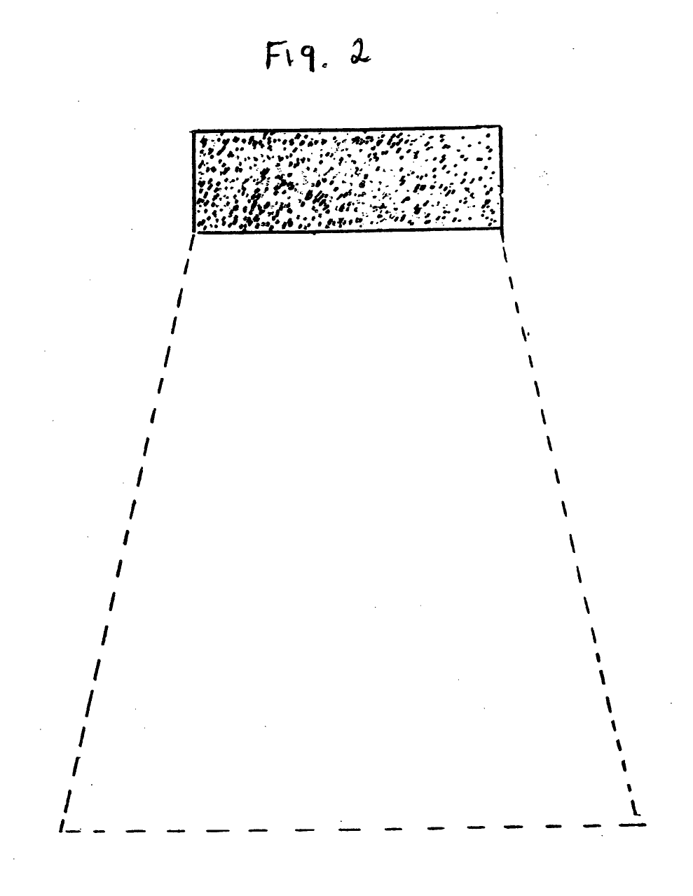

FIG. 1. Show the front side of the workout towel unattached.

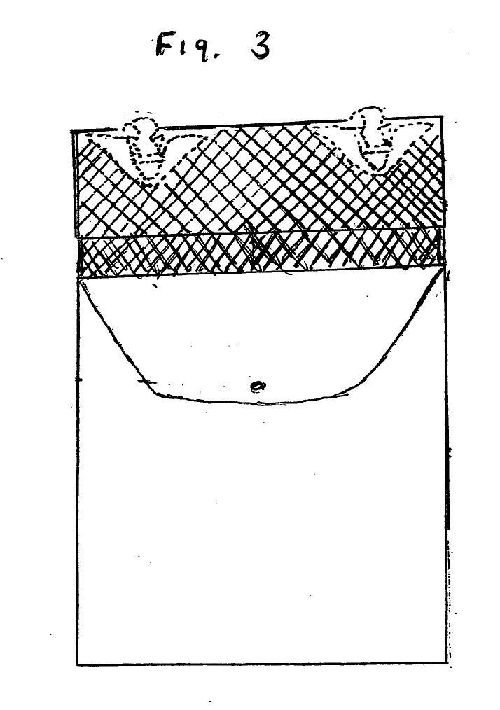

FIG. 2. Show the attachable side of the workout towel, and the top portion that attaches to the accessory pouch.

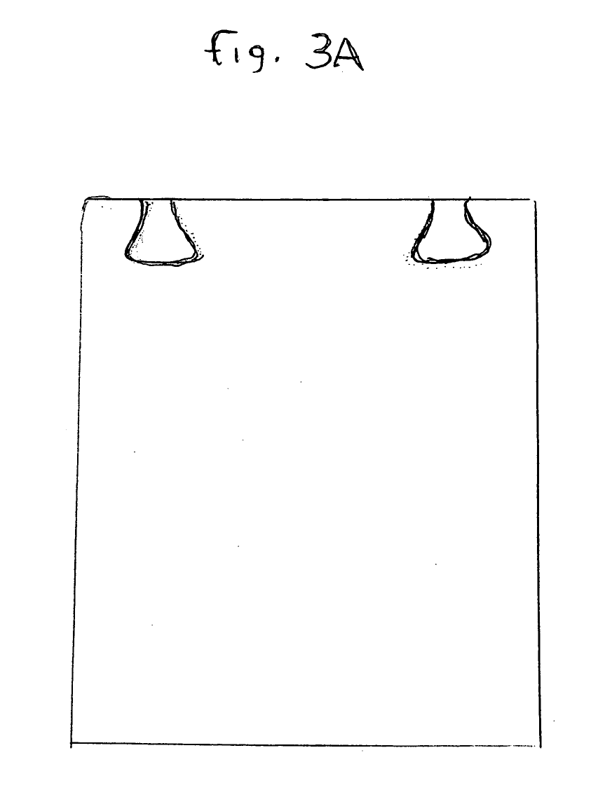

FIG. 3. Show the front side of the pouch and its accessory pocket. Top portion of the accessory pouch is stitched with Velcro. Snap clips are embedded in the top portion on the both ends of the pouch.

FIG. 3a. Show the back side of the accessory pouch. The top portion of the pouch show the snap clips that snaps to the trousers

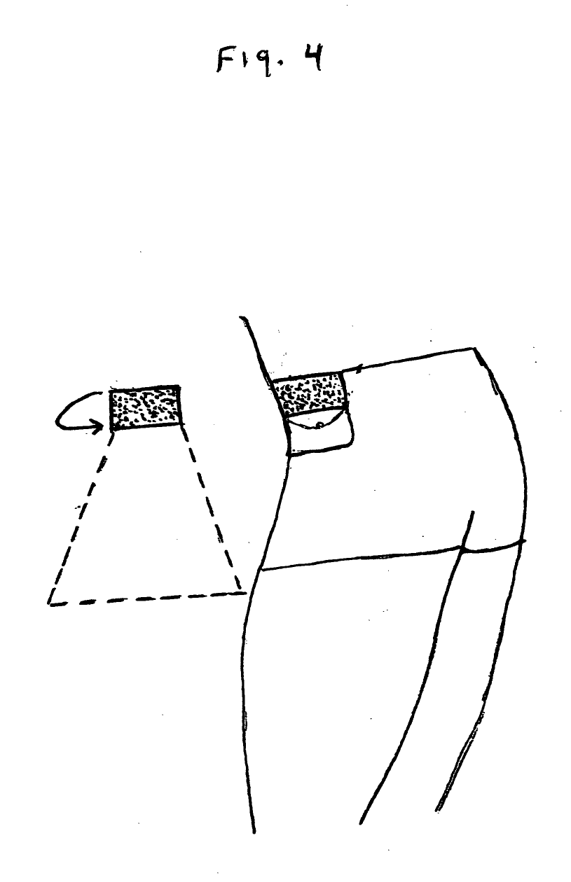

FIG. 4. Show the view of the attachable side of the workout towel and the attachable side of the accessory pouch that is secured to the trousers by snap clips

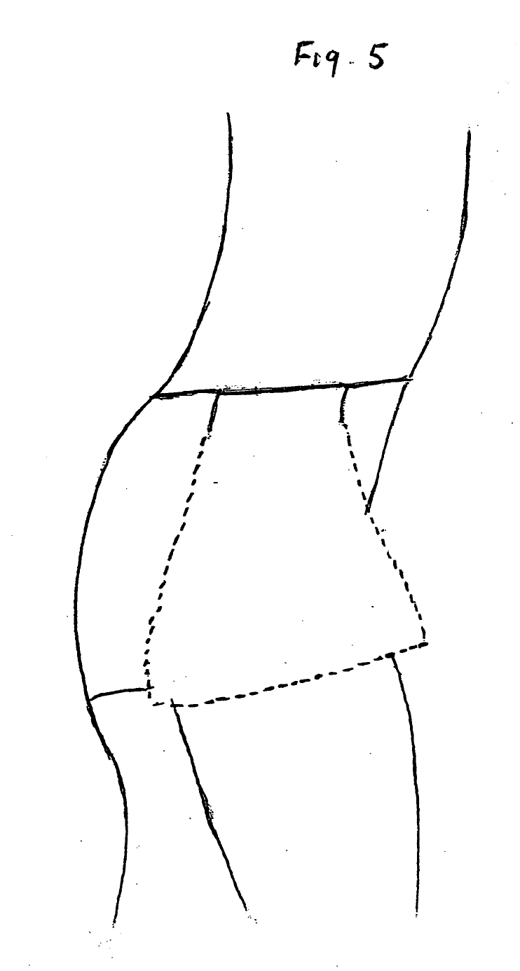

FIG. 5. Show the front view of the workout towel attached to the accessory pouch which is secured to the trousers.

1. The apparatus is a method for allowing the user the convenience of having a perspiration towel complete and detachable to an accessory pouch. The accessory pouch is designed to carry first aid items, music device, cell phone, etc. The towel is designed for use without the burden of the weight of the accessory pouch. The towel is not subject to being left on the work bench, chair backs, locker or any place that may be inconvenient while exercising. This claim of which I am lone the sole claimant and inventor offers no new matter
